(19) United States
(12) Patent Application Publication
(10) Pub. No.: US 2008/0137559 A1
(43) Pub. Date: Jun. 12, 2008

(54) CONFERENCE SYSTEM

(75) Inventors: Yasumasa SASAKI, Tokyo (JP); Shigeru FUKAZAWA, Tokyo (JP); Nobuyuki TAKEDA, Tokyo (JP); Fumikazu MATSUKAWA, Oume-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/857,504

(22) Filed: Sep. 19, 2007

(30) Foreign Application Priority Data
Dec. 7, 2006 (JP) 2006-330943

(51) Int. Cl. H04L 12/16; H04M 3/42; H04Q 11/00

(52) U.S. Cl. 370/260; 379/202.01; 709/204

(57) ABSTRACT

According to one embodiment, a conference system includes: plural terminals that communicate with each other through a communication network; a server that performs a call control for the terminals; and a conference unit that implements a conference among the terminals through the communication network. At least one of the terminals includes a user interface section that accepts an input operation of mode information regarding terminals to participate in the conference and a notification section that notifies the server of the specified mode. The server includes a detection section that detects a remaining amount of a resource of the conference unit necessary to implement the conference and a member determination section that determines plural members to participate in the conference from among the terminals, based on the mode notified by the notification section and the remaining amount of the resource.

### CROSS-REFERENCE TO RELATED APPLICATIONS

This application is based upon and claims the benefit of priority from Japanese Patent Application No. 2006-330943, filed Dec. 7, 2006, the entire contents of which are incorporated herein by reference.

### BACKGROUND

1. Field

One embodiment of the invention relates to a conference system implemented as one application of a telephone system using an Internet Protocol (IP) technology.

2. Description of the Related Art

A system for realizing voice telephone conversation through a best effort type communication network such as the Internet is known. This kind of system is called an IP telephone system or Voice over IP (VoIP) and is applied not only to a wide area telephone network, but also to a local communication network such as a private telephone network. Hereinafter, a telephone terminal in this kind of system will be referred to as IP telephone including a fixed telephone and a soft phone.

In recent years, using this kind of system, a conference system also called a visual communication system has begun to be widely provided. Japanese Patent Application Publication No. 2006-270166 discloses a system wherein a voice communication using a telephone exchange (which will be hereinafter referred to as an exchange), which is conventionally widely used and a video communication using a visual communication server (VCS server) are operatively connected to each other.

A general control mode of the visual communication system is as follows. When a call state between extension terminals connected to an exchange changes, a call information event (originating (calling) device information, incoming (called) device information) is sent from the exchange. The VCS server receives the call information event and interprets the connection state between the extension terminals based on the received event. The VCS server instructs the start/end of visual communications to visual clients associated with the extension terminals according to the connection state.

Incidentally, in recent years, a technique to combine conferences by a unit called Multi-point Control Unit (MCU) when the number of conference participants (which will be hereinafter referred to as video members) is large has been examined. When the MCU is used to combine conferences, a video stream is established between clients and the MCU.

Although the system using the MCU is convenient, the number of video members is limited by conference resources. This means that if the MCU resources that is available for the conference becomes insufficient, the video-displayed members are selected under the initiative of the system. Thus, the participant members in the conference (video members) do not necessarily become the members desired by the users.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary system drawing to show a conference system according to one embodiment of the present invention;

FIG. 2 is a drawing to show an example of a participant member name list displayed on a screen of a client terminal;

FIG. 3 is a drawing to show an example of a video image list of participant members displayed on a screen of a client terminal;

FIG. 4 is an exemplary block diagram to show IP telephones in FIG. 1 according to one embodiment;

FIG. 5 is a drawing to show an example of a screen indicating that the resources of MCU 50 are insufficient;

FIG. 6 is a drawing to show an example of a video image list of participant members corresponding to the state in FIG. 4;

FIG. 7 is an exemplary drawing to show a video member selection technique in the conference system according to one embodiment of the present invention;

FIG. 8 is a drawing to show another example of a participant member name list displayed on a screen of a client terminal;

FIG. 9 is a drawing to show another example of a video image list of participant members displayed on a screen of a client terminal;

FIG. 10 is an exemplary schematic drawing to show a state in which a member list is transmitted to a VCS server and member notification and session switching are executed; and

FIG. 11 is an exemplary flowchart to show a processing procedure in the conference system according to one embodiment of the present invention.

### DETAILED DESCRIPTION

Various embodiments according to the invention will be described hereinafter with reference to the accompanying drawings. In general, according to one embodiment of the invention, a conference system includes: plural terminals that communicate with each other through a communication network; a server that performs a call control for the terminals; and a conference unit that implements a conference among the terminals through the communication network. At least one of the terminals includes a user interface section that accepts an input operation of mode information regarding terminals to participate in the conference and a notification section that notifies the server of the specified mode. The server includes a detection section that detects a remaining amount of a resource of the conference unit necessary to implement the conference and a member determination section that determines plural members to participate in the conference from among the terminals, based on the mode notified by the notification section and the remaining amount of the resource.

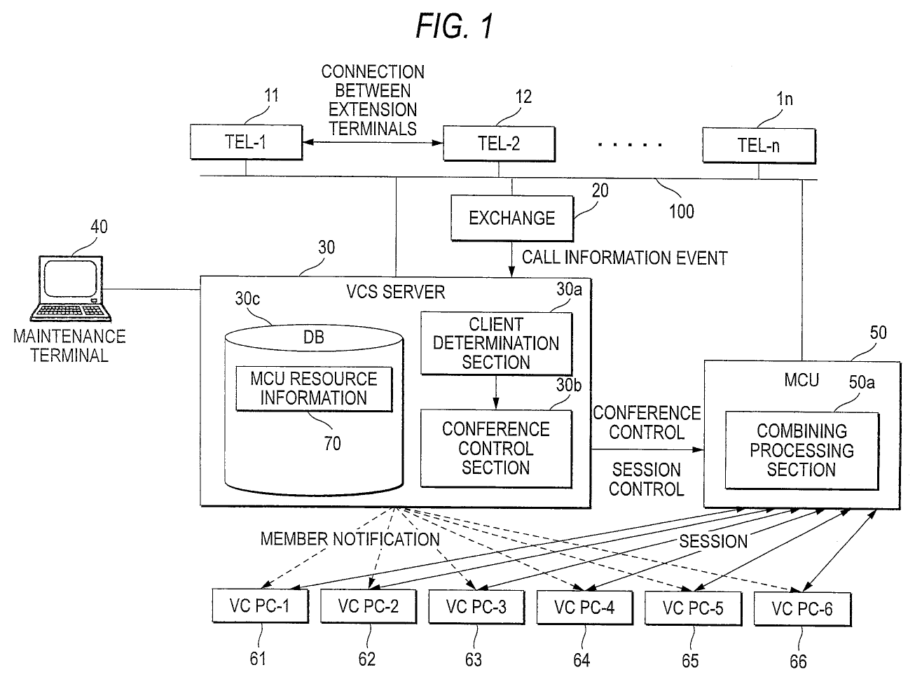

FIG. 1 is an exemplary system drawing to show a conference system according to one embodiment of the present invention. In FIG. 1, plural IP telephones 11 to 1n are connected to an exchange 20 through an IP network 100. The IP telephones 11 to 1n are dedicated telephone terminals, soft phones, etc. A visual communication server (VCS server) 30 and a Multi-Point Control Unit (MCU) 50 are also connected to the IP network 100. The VCS server 30 may be connected to a maintenance terminal 40 that makes various data settings, etc. The VCS server 30 manages the MCU 50 and plural visual clients (VCs) 61 to 66 through the IP network 100. The VCS server 20 performs a call control for the IP telephones 11 to 1n. The visual clients 61 to 66 are objects corresponding to participants that can be conference members; the number of the visual clients is not limited to six.

The MCU 50 includes a combining processing section 50a. The combining processing section 50a combines video data and voice data transmitted through the IP network 100 to implement plural visual communications (conference) in which plural members participate, but resources of the MCU 50 is limited.

The VCS server 30 includes a client determination section 30a, a conference control section 30b, and a database (DB) 30c. The client determination section 30a determines the members (client terminals) to participate in a conference. The conference control section 30b detects a remaining amount of the resources of the MCU 50 to implement a conference and store the remaining amount in MCU resource information 70. The conference control section 30b determines members to participate in a conference according to the resource remaining amount. The members are selected in a mode based on a client's request and a notification is sent to the visual clients 61 to 66. When a conference starts, the MCU 50 receives session control information reflecting the member composition from the conference control section 30b and forms a session only among the selected members.

The database 30c stores the MCU resource information 70, namely, information as a database of the resources of the MCU 50 to implement visual communications. The MCU resource information 70 may change with a version upgrade of the system.

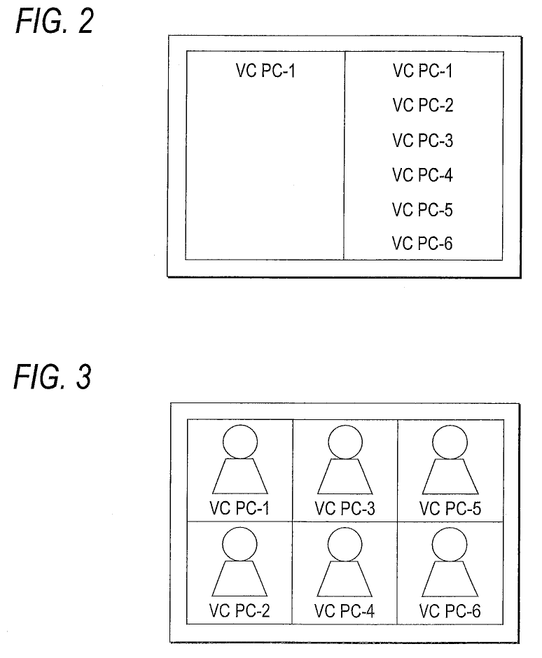

In a state in which the resources of the MCU 50 are sufficient, a session is established among all visual clients 61 to 66 and the MCU 50 as shown in FIG. 1 and all conference members participate in the conference. Each of the visual clients 61 to 66 is notified of the conference members; the participant member names are displayed on each client terminal as in an example in FIG. 2 and video images of all participant members are displayed as in an example in FIG. 3. The client terminals are the IP telephones 11 to in or computer terminals operating in association with the telephones.

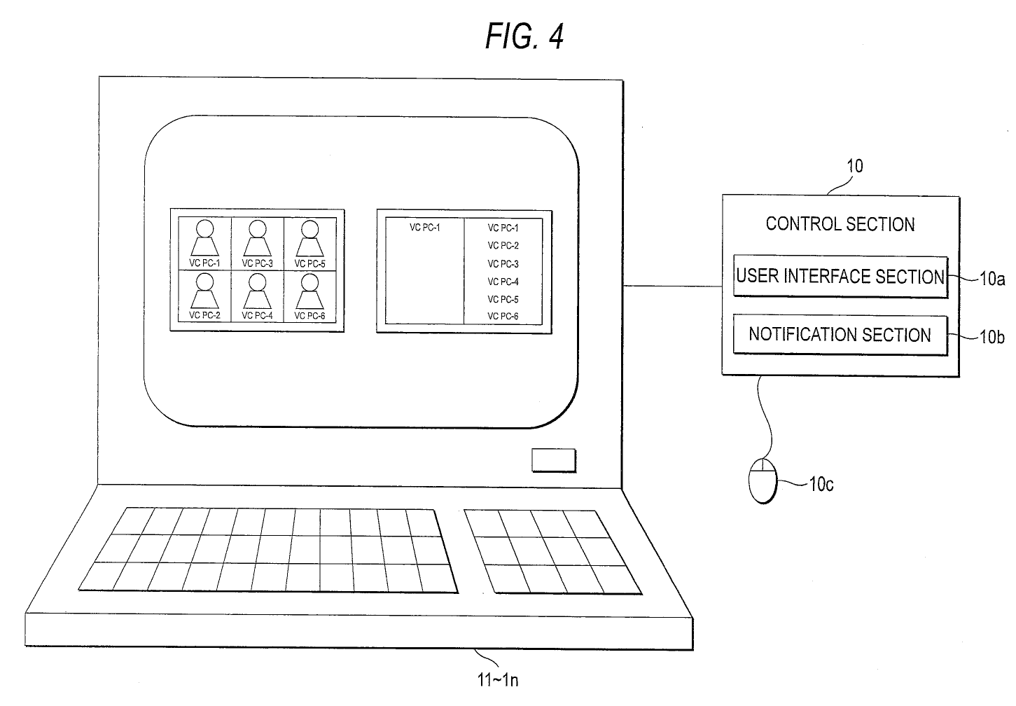

FIG. 4 is an exemplary block diagram to show one embodiment of the IP telephones 11 to in (client terminals) in FIG. 1. If the IP telephones 11 to in are soft phones, they are implemented as computers and each includes a monitor, a control section 10, and a mouse 10c. The control section 10 includes a user interface section 10a and a notification section 10b as processing functions. The user interface section 10a accepts user operation in response to a Graphical User Interface (GUI) message, etc., displayed on a monitor screen. The notification section 10b sends the user operation description to the VCS server 30 as an event.

Particularly, in the embodiment, the notification section 10b sends a notification of the conference member selection mode specified through the user interface section 10a to the VCS server 30. The windows in FIGS. 2 and 3 are displayed on the monitor screen. At default, the users of all the IP telephones 11 to 1n (visual clients 61 to 66) may have the authority to specify the member selection mode. Alternatively, only specific users of a system administrator, etc., may have the authority or only the organizer of the conference may have the authority. The authority can be granted in any manner by setting the user interface section 10a. To change the setting of the user interface section 10a, the maintenance terminal 40, etc., is used.

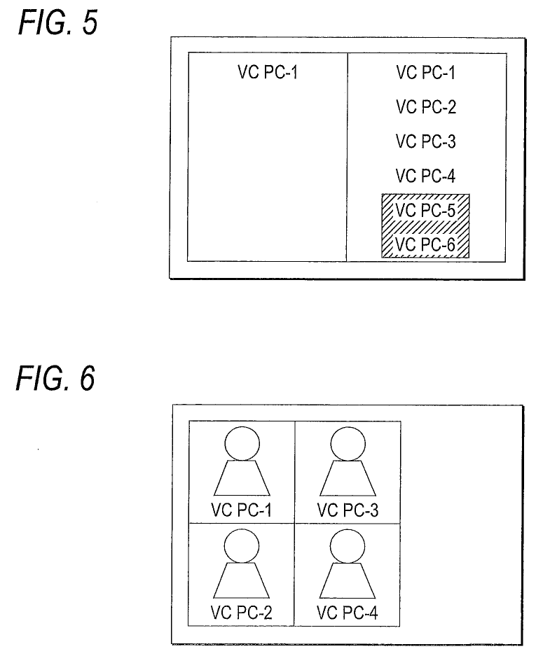

FIG. 5 shows an example of a screen indicating that the resources of the MCU 50 are insufficient. It shows that the resources are insufficient for two clients. That is, the members that cannot participate in the conference are not video-displayed as they are grayed, etc., for example, according to the member notification information from the VCS server 30. Here, the visual clients 65 and 66 (PC-5 and PC-6) are not video-displayed as shown in FIG. 6. Incidentally, in the already existing art, the video-displayed visual clients 61 to 66 (PC-1 to PC-6) are members determined based on the system logic and may not necessarily be members desired by the users.

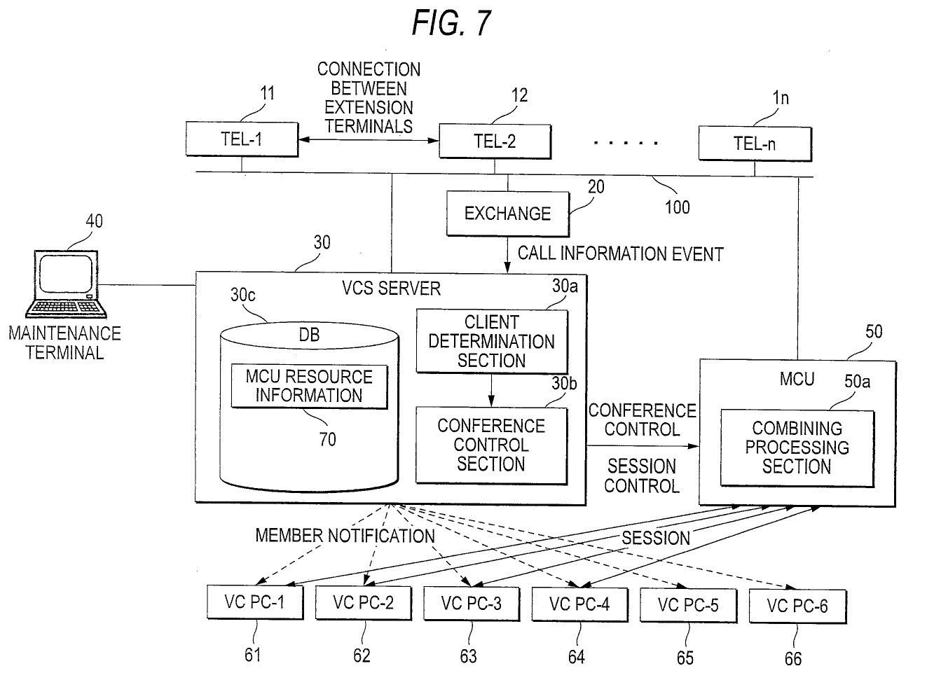

FIG. 7 is an exemplary drawing to show a video member selection technique in the embodiment. For example, when any desired video members are selected on the client terminal of the IP telephone 11, list information of the selected members is sent to the VCS server 30, which then determines the clients based on the member list information and performs a session control and a conference control.

The participant member limiting mode is, for example, a mode of setting an order of priority among the members or a mode of selecting any desired members from a list of all members displayed on the monitor screen of the client to create a member list. As a mode to a video conference, a mode of setting a lower priority to a client having no video camera function (the function is inactive) or removing the client from the object of the selection is also available. In this case, the member may be undisplayed in the list.

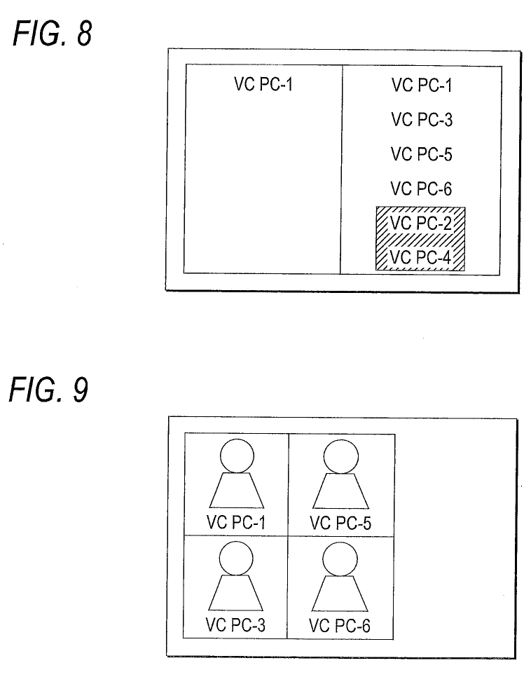

In FIG. 7, the visual clients 61, 63, 65, and 66 are determined new video members and the session to the visual clients 62 and 64 is disconnected from the state in FIG. 1 and a new session of the visual clients 65 and 66 is established. Consequently, PC-2 and PC-4 are grayed on the member display as shown in an example in FIG. 8 and video images of PC-1, PC-3, PC-5, and PC-6 are displayed as shown in an example in FIG. 9.

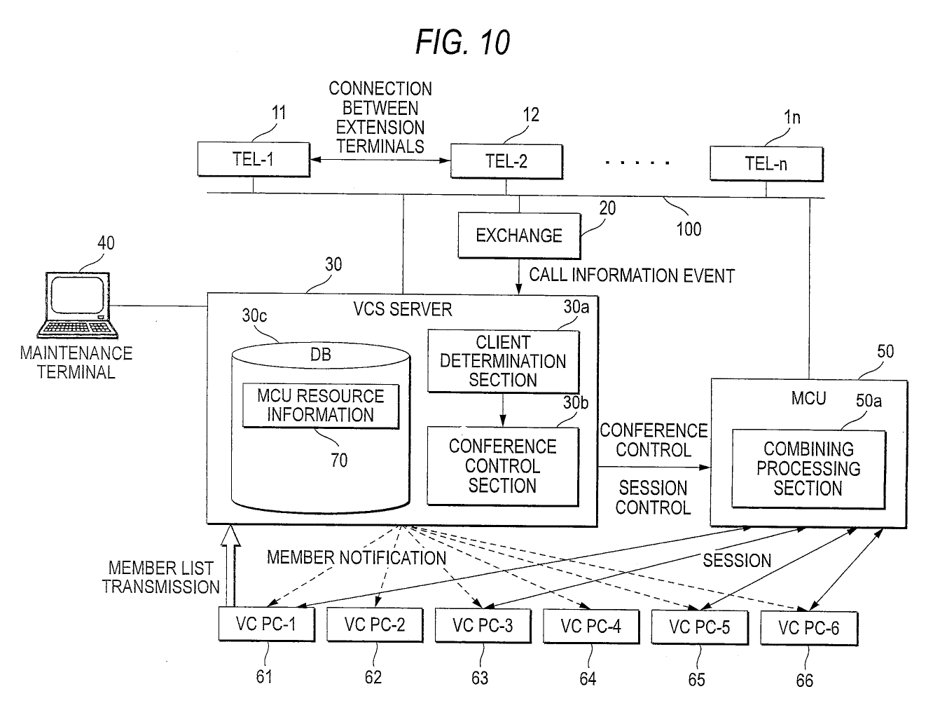

The selected member list information transmitted to the VCS server 30 as shown in FIG. 10 has a format such as a priority format (PC-1>PC-3>PC-5>PC-6 [>PC2>PC-4], etc.,) or a member list format (PC-1, PC-3, PC-5, PC-6). The information may be transmitted particularly based on Session Initiation Protocol (SIP) in an eXtended Markup Language (XML).

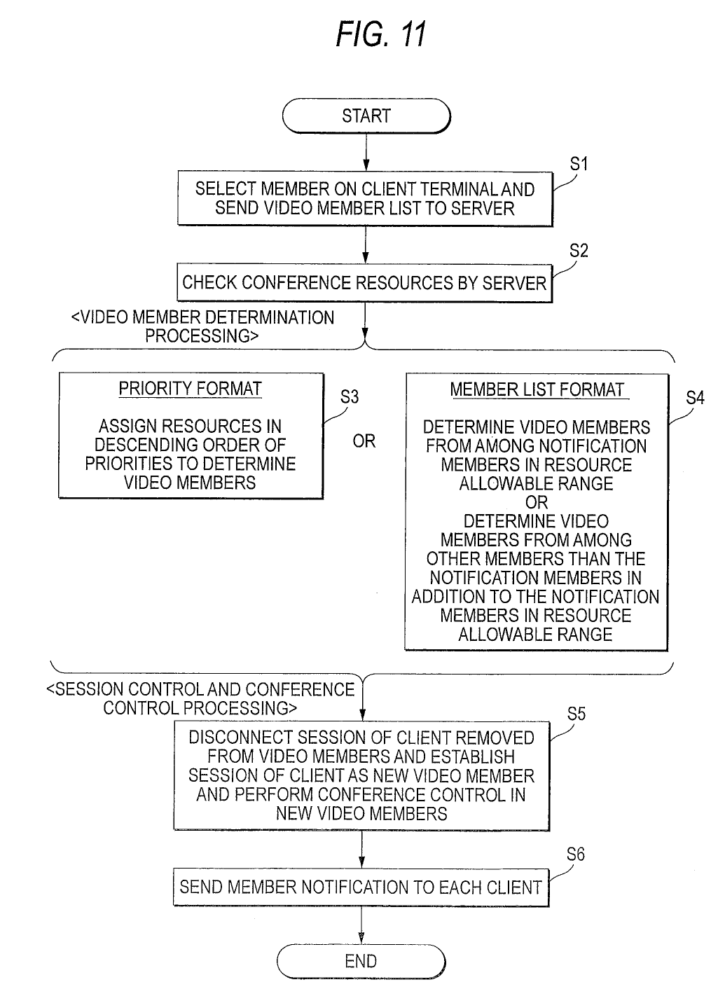

FIG. 11 is an exemplary flowchart to show a processing procedure in the configuration described above. In FIG. 11, when members to participate in a conference are selected at a client terminal, a video member list indicating the selected members is sent to the VCS server 30 (block S1). Upon reception of the video member list, the VCS server 30 checks the remaining amount of the conference resources and keeps track of how many members (client terminals) can participate in the conference (step S2).

### <Video Member Determination Processing>

If the member list information from the client is in the priority format, the resources are assigned in the descending order of the priorities (high to low) to determine the video members (block S3). If the member list information is in the member list format, the video members are determined from among the notification members in the resource allowable range or the video members are determined from among other members than the notification members in addition to the notification members in the resource allowable range (block S4).

### <Session Control and Conference Control Processing>

The session of the client terminal which is removed from the video members is disconnected according to the information from the video member determination processing and a session of a client terminal as a new video member is established. Conference control is performed in the new video members (block S5). Last, a member notification is sent to each client terminal (block S6).

As described above, a conference system includes: the plural terminals 11 to 1n or visual clients 61 to 66 that communicate with each other through the IP network 100; the VCS server 30 that performs a call control for the plural terminals 11 to 1n; and the MCU (conference unit) 50 that implements a conference among the terminals 11 to 1n through the IP network 100. At least one of the plural terminals 11 to 1n includes a user interface section 10a that accepts an input operation of mode information regarding terminals to participate in the conference and a notification section 10b that notifies the VCS server 30 of the specified mode. The VCS server 30 includes the conference control section (detection section) 30b that detects a remaining amount of a resource of the MCU 50, the resource being necessary to implement the conference and a client determination section (member determination section) 30a that determines plural members to participate in the conference from among the plural terminals 11 to in, based on the mode notified by the notification section 10b and the remaining amount of the resource.

The mode information may include an order of priority among the plurality of terminals, and the member determination section may determine the plurality of members to participate in the conference from among the plurality of terminals according to the order of priority and the remaining amount of the resource.

The user interface section may display a first list indicating a first group of the terminals, the user interface section may accept the input operation to select a second group of the terminals from the first group through the user interface section, the notification section may notify the server of a second list indicating the second group of the terminals, and the member determination section may determine the members to participate in the conference based on the second list and the remaining amount of the resource.

If the remaining amount is sufficient to allow all the terminals included in the first group to participate in the conference, the member determination section may determine all the terminals as the members to participate in the conference.

The mode information may be set so that a terminal which does not have a video image obtaining function is set to a low priority when the conference uses video images.

The first group indicated in the first list may not include a terminal which does not have a video image obtaining function when the conference uses video images.

User interface sections of all the terminals included in the first group may accept the input operation to select the second group of the terminals from the first group.

A user interface section of an authorized terminal included in the first group may accept the input operation to select the second group of the terminals from the first group.

Only a user interface section of an organizing terminal of the conference included in the first group may accept the input operation to select the second group of the terminals from the first group.

As described above, in the embodiment, if not all the members can participate in the conference as a result of detecting the resources of the MCU 50, the conference members are again determined based on the video member list sent from one of the client terminal to the VCS server 30. Accordingly, if only some members can participate in the video conference because of shortage of the conference resources, it is made possible to select the video members according to the user's demand and it is made possible to perform flexible visual communication control. That is, according to the embodiment, it is made possible to flexibly determine the video members and accordingly it is made possible to provide a conference system that can perform visual communications in the mode desired by the user if the conference resources become insufficient.

In other words, as described above, the remaining amount of the resources of the MCU are momentarily detected or monitored. For example, if the number of conferences held at the same time is too large or the number of participant members is too large, the resources of the MCU become insufficient and thus it becomes necessary to limit the conference members. On the other hand, a notification reflecting a user's request such that what member composition is set, in other words, what mode the members are limited in is transmitted from a client terminal to the server. Then, if the conference members have to be limited, the server again determines the members to participate in the conference according to the notification description. Therefore, if only some members can participate in the video conference because of shortage of the recourses, it is made possible to select the video members in response to the user's demand. Thus, it is made possible to flexibly determine the video members and accordingly it is made possible to conduct visual communications in the mode desired by the user if the conference resources become insufficient.

The invention is not limited to the specific embodiment described above. For example, if a system does not have the MCU 50 or the resources of the MCU 50 are extremely small, a peer-to-peer mesh session may be established between the clients.

Further, it is to be understood that the invention is not limited to the specific embodiment described above and that the invention can be embodied with the components modified without departing from the spirit and scope of the invention. The invention can be embodied in various forms according to appropriate combinations of the components disclosed in the embodiment described above. For example, some components may be deleted from all components shown in the embodiment.

What is claimed is:

1. A conference system comprising:
a plurality of terminals that communicates with each other through a communication network;
a server that performs a call control for the plurality of terminals; and
a conference unit that implements a conference among the terminals through the communication network,
wherein at least one of the plurality of terminals comprises:
a user interface section that accepts an input operation of mode information regarding terminals to participate in the conference; and
a notification section that notifies the server of the specified mode, and
wherein the server comprises:
a detection section that detects a remaining amount of a resource of the conference unit, the resource being necessary to implement the conference; and
a member determination section that determines a plurality of members to participate in the conference from among the plurality of terminals, based on the mode notified by the notification section and the remaining amount of the resource.

2. The conference system according to claim 1,
wherein the mode information includes an order of priority among the plurality of terminals, and
wherein the member determination section determines the plurality of members to participate in the conference from among the plurality of terminals according to the order of priority and the remaining amount of the resource.

3. The conference system according to claim 1,
wherein the user interface section displays a first list indicating a first group of the terminals,
wherein the user interface section accepts the input operation to select a second group of the terminals from the first group through the user interface section,
wherein the notification section notifies the server of a second list indicating the second group of the terminals, and
wherein the member determination section determines the members to participate in the conference based on the second list and the remaining amount of the resource.

4. The conference system according to claim 3,
wherein if the remaining amount is sufficient to allow all the terminals included in the first group to participate in the conference, the member determination section determines all the terminals as the members to participate in the conference.

5. The conference system according to claim 2,
wherein the mode information is set so that a terminal which does not have a video image obtaining function is set to a low priority when the conference uses video images.

6. The conference system according to claim 3,
wherein the first group indicated in the first list does not include a terminal which does not have a video image obtaining function when the conference uses video images.

7. The conference system according to claim 3,
wherein user interface sections of all the terminals included in the first group accept the input operation to select the second group of the terminals from the first group.

8. The conference system according to claim 3,
wherein a user interface section of an authorized terminal included in the first group accepts the input operation to select the second group of the terminals from the first group.

9. The conference system according to claim 3,
wherein only a user interface section of an organizing terminal of the conference included in the first group accepts the input operation to select the second group of the terminals from the first group.

10. A computer comprising:
a controller that controls a communication among a plurality of terminals through a network;
a detector that detects a remaining resource in a conference unit that implements a conference among the plurality of terminals;
a receiver that receives a mode information regarding members to participate in the conference from at least one of the terminals;
a determination section that determines members to participate in the conference from among the plurality of terminals, based on the received mode information and the detected remaining resource; and
a notifying section that notifies the conference unit and the terminals of a result of the determination.
